(19) United States
(12) Patent Application Publication
(10) Pub. No.: US 2026/0356138 A1
(43) Pub. Date: Nov. 12, 2026

(54) AIR PRESSURE MANAGEMENT DEVICE AND AIR PRESSURE MANAGEMENT METHOD

(71) Applicant: The Yokohama Rubber Co., LTD., Kanagawa (JP)

(72) Inventor: Jun MATSUDA, Kanagawa (JP)

(21) Appl. No.: 19/515,086

(22) PCT Filed: Sep. 6, 2024
(86) PCT No.: PCT/JP2024/031968

§ 371 Date: Feb. 27, 2026

(30) Foreign Application Priority Data
Sep. 11, 2023 (JP) 2023-146987

(51) Int. Cl. B60C 23/04

(52) U.S. Cl. CPC B60C 23/0479

(57) ABSTRACT

An air pressure management device determines presence or absence of a tire abnormality and a type of the abnormality based on a comparison between reference air pressure and temperature-converted air pressure. A first abnormality determination unit determines that there is an abnormality in the tire if a difference between the reference air pressure and the temperature-converted air pressure is equal to or greater than a first threshold and determines that the type of the abnormality is a puncture of the tire if the difference is equal to or greater than a second threshold greater than the first threshold. A second abnormality determination unit determines whether the type of the abnormality is a slow leak of the tire or a natural leakage of the tire if the difference is equal to or greater than the first threshold and less than the second threshold.

### TECHNICAL FIELD

The present technology relates to an air pressure management device and an air pressure management method for managing air pressure of tires.

### BACKGROUND ART

Driving stability of a vehicle is ensured by appropriately managing air pressure of tires mounted on the vehicle. In recent years, attempts have been made to provide tires with tire pressure monitoring system (TPMS) sensors and manage air pressure information obtained from the TPMS sensors via the cloud (see, for example, Japan Unexamined Patent Publication No. 2021-046160 A). With this type of technology, when the air pressure of the tire decreases below a certain threshold value, a driver or a vehicle manager is notified of this air pressure abnormality, allowing tire maintenance work to be carried out promptly.

This type of air pressure abnormality includes a so-called puncture that causes the air pressure to decrease suddenly during a short period of time, for example, a few minutes to a few tens of minutes as well as a so-called slow leak (slow puncture) that causes the air pressure to decrease slowly during a period of time, for example, a few hours to a few days and a so-called natural leakage that causes the air pressure to decrease gradually over a long period of time, for example, one month to several months. When an air pressure abnormality occurs, maintenance work can be done by simply refilling the air pressure if it is a natural leakage, for example, but in the case of a slow leak or a puncture, it is necessary to inspect the valve or remove the tire from the rim and inspect the tire. As described above, the content of the maintenance work varies depending on the type of air pressure abnormality, and therefore it is necessary to accurately determine the cause of the air pressure abnormality. However, it is difficult to accurately determine the cause of these air pressure abnormalities, and there is room for improvement.

### SUMMARY

The present technology provides an air pressure management device and an air pressure management method that can accurately determine a cause of an air pressure abnormality in a tire and reduce maintenance work of the tire.

An air pressure management device according to an embodiment of the present technology includes: an information acquisition unit configured to acquire sensor information including air pressure and temperature of tires mounted on a vehicle at a predetermined timing; a reference information setting unit configured to set reference information including reference air pressure and reference temperature of a tire of the tires; a temperature-converted air pressure calculation unit configured to calculate temperature-converted air pressure of the tire at the reference temperature based on the sensor information and the reference information; and an abnormality determination unit configured to determine presence or absence of an abnormality in the tire and a type of the abnormality based on a result of comparison between the reference air pressure and the temperature-converted air pressure. The abnormality determination unit includes a first abnormality determination unit configured to determine that there is an abnormality in the tire if a difference value between the reference air pressure and the temperature-converted air pressure is equal to or greater than a first threshold value and determine that the type of the abnormality is a puncture of the tire if the difference value is equal to or greater than a second threshold value that is greater than the first threshold value and a second abnormality determination unit configured to determine whether the type of the abnormality is a slow leak of the tire or a natural leakage of the tire if the difference value is equal to or greater than the first threshold value and less than the second threshold value.

An air pressure management method according to an embodiment of the present technology includes: acquiring sensor information including air pressure and temperature of tires mounted on a vehicle at a predetermined timing; setting reference information including reference air pressure and reference temperature of a tire of the tires; calculating temperature-converted air pressure of the tire at the reference temperature based on the sensor information and the reference information; and determining presence or absence of an abnormality in the tire and a type of the abnormality based on a result of comparison between the reference air pressure and the temperature-converted air pressure. The step of determining presence or absence of an abnormality in the tire and a type of the abnormality includes determining that there is abnormality in the tire if a difference value between the reference air pressure and the temperature-converted air pressure is equal to or greater than a first threshold value, determining that the type of the abnormality is a puncture of the tire if the difference value is equal to or greater than a second threshold value that is greater than the first threshold value, and determining whether the type of the abnormality is a slow leak of the tire or a natural leakage of the tire if the difference value is equal to or greater than the first threshold value and less than the second threshold value.

In an embodiment of the present technology, the cause of an air pressure abnormality in a tire can be determined with high accuracy, thereby achieving a reduction in tire maintenance work.

### BRIEF DESCRIPTION OF DRAWINGS

FIG. 1 is a block diagram illustrating an overall configuration of an air pressure management system including an air pressure management device according to a first embodiment.

FIG. 2 is a block diagram illustrating a functional configuration of a cloud server of the air pressure management system.

FIG. 3 is a graph illustrating a relationship between a ratio of an inner surface area of a tire to an internal volume of the tire and a monthly natural leakage rate.

FIG. 4 is a flowchart illustrating an operation procedure of the air pressure management system.

FIG. 5 is a flowchart illustrating an operation procedure of a puncture determination process.

FIG. 6 is a flowchart illustrating an operation procedure of a puncture determination process according to the second embodiment.

FIG. 7 is a graph illustrating changes in temperature-converted air pressure and temperature of a tire over time.

FIG. 8 is a block diagram illustrating a functional configuration of a cloud server according to a third embodiment.

### DETAILED DESCRIPTION

An embodiment of an air pressure management device according to the present technology will be described below with reference to the drawings. The present technology is not limited to the present embodiment. The components in the present embodiment include those that can be substituted and easily conceived by those skilled in the art, or those that are substantially the same.

The air pressure management device according to the present embodiment centrally manages the air pressures of tires (pneumatic tires) mounted on a plurality of vehicles. Specifically, the air pressure management device is suitable for centrally managing the air pressure of tires mounted on a large number of vehicles owned by a business entity, such as taxis, or on a large number of shared vehicles owned by a business entity and used jointly by a large number of users, such as car sharing or rental cars. In the present embodiment, a case where the air pressure management device is used in a car sharing business will be described as an example.

The car sharing business is a service that rents out shared vehicles to pre-registered users and allows these shared vehicles to be used jointly by the users. In a car sharing business, a plurality of shared vehicles are parked in parking spaces called stations. The number of shared vehicles parked at the station and the number of stations scattered within a predetermined area are determined appropriately depending on the scale of the business and the like. When a user uses a shared vehicle, the station is the departure point and the return point of the shared vehicle. In the present embodiment, for example, when a shared vehicle is returned to a station, the presence or absence of an air pressure abnormality of the shared vehicle and the type of abnormality are determined under the management of the air pressure management device. When an air pressure abnormality occurs, the air pressure management device notifies a vehicle manager who manages the relevant shared vehicle or station.

### First Embodiment

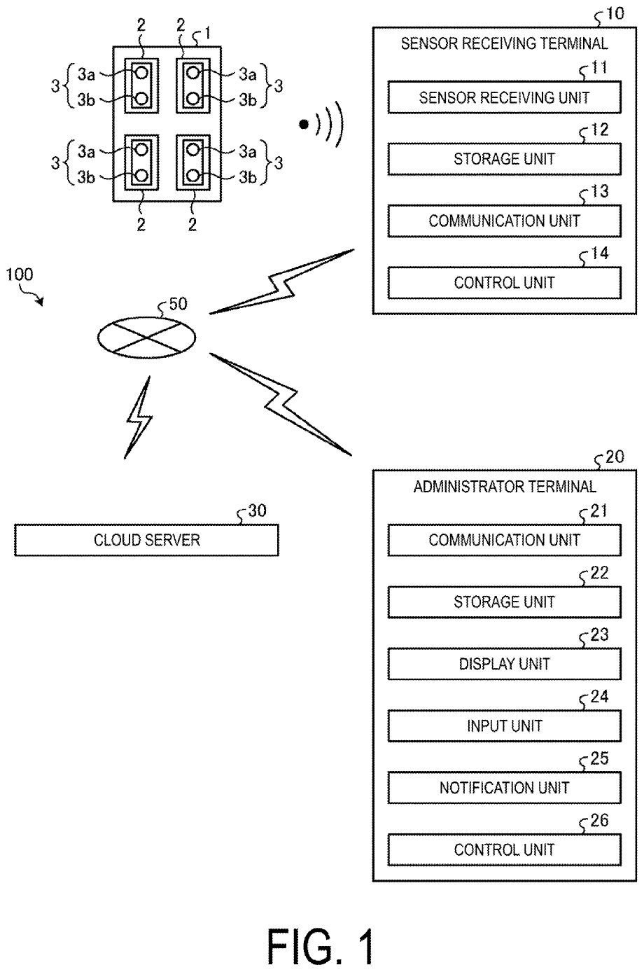

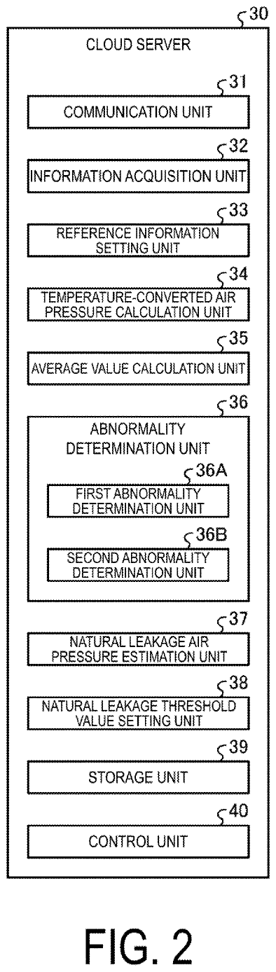

FIG. 1 is a block diagram illustrating an overall configuration of a tire pressure management system including an air pressure management device according to a first embodiment. FIG. 2 is a block diagram illustrating a functional configuration of a cloud server of the tire pressure management system. As illustrated in FIG. 1, the tire pressure management system 100 includes sensors 3 provided in each tire 2 of a plurality of shared vehicles (vehicles) 1, a sensor receiving terminal 10 installed at a station where the plurality of shared vehicles 1 are parked, an administrator terminal 20 that manages this station, and a cloud server (air pressure management device) 30. The sensor receiving terminal 10, the administrator terminal 20, and the cloud server 30 are communicatively connected via a communication network 50 such as the Internet line. The cloud server 30 is also communicatively connected to a car sharing management server (not illustrated) owned by the car sharing business entity via a communication network 50. This car sharing management server accepts reservations from users for use of a plurality of shared vehicles and creates usage schedule information for the reserved shared vehicles. This usage schedule information includes vehicle information of the shared vehicle 1, user information, usage start time, usage end time, and information about stations that are the departure point and return point. In the example of FIG. 1, for convenience, one shared vehicle 1, one sensor receiving terminal 10, and one administrator terminal 20 are illustrated, but in reality, a plurality of shared vehicles 1, a plurality of sensor receiving terminals 10, and a plurality of administrator terminals 20 are provided.

The sensor 3 has at least a tire pressure monitoring system (TPMS) function, and includes a pneumatic sensor 3a that detects the air pressure of the tire 2 and a temperature sensor 3b that detects the temperature of the air inside the tire 2. The sensor 3 may further include an acceleration sensor that detects the centrifugal acceleration acting on the tire 2, and may also be configured to appropriately add a piezoelectric sensor, a capacitance sensor, a magnetic sensor, a MEMS (micro-electromechanical systems) microphone sensor, or the like to implement additional detection functions such as wear detection, road surface detection, failure detection, and detection of loose mounting bolts. The sensors 3 are attached to the inner surface of the tire 2. As a result, the sensor 3 is less susceptible to the influence of the environment in the space outside the tire 2, and the air pressure and temperature of the tire 2 can be easily detected with a simple operation such as replacing the tire 2 with one equipped with the sensor 3. Each sensor 3 is assigned a sensor ID (identification information), and a correspondence relationship between the sensor ID of the sensor 3 and the wheel position (left front wheel, right front wheel, left rear wheel, or right rear wheel) of the tire 2 equipped with the sensor 3 is registered in the sensor receiving terminal 10. The sensor 3 is equipped with a battery that serves as a driving power source, and, for example, while the shared vehicle 1 is parked at the station, it detects air pressure and temperature data (sensor information) every predetermined time (for example, 3 minutes), and transmits this detected data to the sensor receiving terminal 10 together with the sensor ID (identification information). This configuration makes it possible to detect a change (decrease) in the air pressure of the tire 2 after the shared vehicle 1 is returned to a predetermined station (for example, during the night hours). The battery life of the sensor 3 is set to be longer than the service life of a typical tire 2. Data transmission from the sensor 3 to the sensor receiving terminal 10 can be performed using short-range wireless communication such as radio frequency (RF) communication. The data detected by each sensor 3 is stored in a predetermined storage unit and may be transmitted to the sensor receiving terminal 10 using the above-described short-range wireless communication, for example, while the shared vehicle 1 is parked at the station.

In addition to the above-described sensor 3, the shared vehicle 1 may also be provided with various sensors for detecting vehicle information (for example, a global navigation satellite system (GNSS) receiving sensor for receiving GNSS signals, an engine operation detection sensor for detecting whether the engine is on or off, and a vehicle speed pulse detection sensor).

These sensors can be used, for example, to calculate the vehicle utilization rate (for example, the percentage of travel time per day). In the present embodiment, the sensor 3 is configured to directly detect the air pressure and temperature of the tire 2, but the temperature is not limited to the temperature inside the tire, and it may also be a sensor provided in the vehicle that detects the outside air temperature. Instead of a configuration that directly measures air pressure, table data showing the relationship between air pressure and a physical quantity that correlates with air pressure (for example, wheel rotation speed) may be created in advance, and the air pressure may be acquired from the detected physical quantity and the table data. This configuration can be used to simply manage the air pressure of the tire 2 even in a configuration in which the tire 2 is not provided with a TPMS sensor (sensor 3).

The sensor receiving terminal 10 is installed at a station where the shared vehicle 1 is parked. As illustrated in FIG. 1, the sensor receiving terminal 10 includes a sensor receiving unit 11, a storage unit 12, a communication unit 13, and a control unit 14. The sensor receiving unit 11 receives data transmitted from the sensors 3 of the four tires 2 of each shared vehicle 1. The sensor receiving unit 11 also receives data transmitted from various sensors mounted on the vehicle. The storage unit 12 includes storage means such as a volatile or nonvolatile memory or an HDD. The storage unit 12 stores various programs to be executed by the control unit 14 and various types of data. In the present embodiment, the storage unit 12 determines a corresponding shared vehicle 1 and wheel position from the sensor ID of the data received by the sensor receiving unit 11 every predetermined time, and stores the air pressure and temperature (including correlated physical quantities and temperatures) of each tire 2 included in the received data as historical information about tire air pressure and temperature of the tire at each wheel position of the corresponding shared vehicle 1. The storage unit 12 may store the air pressure and temperature of each tire 2 for a predetermined period (for example, the most recent six months) while updating the air pressure and temperature. When the tires 2 are rotated in the shared vehicle 1, it is assumed that the correspondence relationship between the sensor IDs registered in the sensor receiving terminal 10 and the wheel positions is corrected. The storage unit 12 also stores data relating to the vehicle utilization state and the like, received by the sensor receiving unit 11 every predetermined time, as historical information on the utilization state of the shared vehicle 1.

The communication unit 13 is configured to be able to wirelessly communicate with the cloud server 30 via the communication network 50. The communication unit 13 transmits, to the cloud server 30, the air pressure information of the tires 2 mounted on the shared vehicle 1 together with the vehicle ID of the shared vehicle 1 every predetermined time. Specifically, the communication unit 13 transmits, to the cloud server 30, air pressure information including the air pressure and temperature (including correlated physical quantities and temperatures) of the tires 2 of each shared vehicle 1 corresponding to the sensor ID. The communication unit 13 transmits, to the cloud server 30, historical information about the utilization state of each shared vehicle 1.

The control unit 14 has a CPU and performs predetermined processing based on the received air pressure information of each tire 2 of each shared vehicle 1, data related to the utilization state of the vehicle, or data stored in the storage unit 12.

The cloud server 30 centrally manages the air pressures of the tires 2 of a plurality of shared vehicles 1. The cloud server 30 acquires and stores the air pressure information or the like of each tire 2 of the shared vehicle 1 transmitted from the sensor receiving terminal 10 and determines the presence or absence of an air pressure abnormality in each tire 2 and the type of abnormality. When the air pressure abnormality in the tire 2 is determined, the cloud server 30 transmits the occurrence of the air pressure abnormality and the type of abnormality to the administrator terminal 20 that manages the station of the shared vehicle 1 on which the tire 2 is mounted.

The cloud server 30 includes, for example, a computer or the like installed in a cloud. As illustrated in FIG. 2, the cloud server 30 includes a communication unit 31, an information acquisition unit 32, a reference information setting unit 33, a temperature-converted air pressure calculation unit 34, an average value calculation unit 35, an abnormality determination unit 36, a natural leakage air pressure estimation unit 37, a natural leakage threshold value setting unit 38, a storage unit 39, and a control unit 40.

The communication unit 31 is configured to be able to wirelessly communicate with the sensor receiving terminal 10 and the administrator terminal 20 via the communication network 50. The communication unit 31 receives each piece of data (sensor information) of the shared vehicle 1 and the tire 2 transmitted from the sensor receiving terminal 10. When an air pressure abnormality in the tire 2 occurs, information such as the occurrence of the air pressure abnormality and the type of air pressure abnormality is transmitted to the administrator terminal 20 that manages the station where the shared vehicle 1 is parked.

The information acquisition unit 32 acquires vehicle information (for example, sensor information about the vehicle utilization state and the like) of the shared vehicle 1 received from the sensor receiving terminal 10 via the communication unit 31 and air pressure information (sensor information) of each tire 2 of the shared vehicle 1 at a predetermined timing. This predetermined timing can be set as appropriate, but for example, in order to accurately determine the presence or absence of an air pressure abnormality in each tire 2, the air pressure information of each tire 2 collected by the sensor receiving terminal 10 may be acquired every predetermined time (for example, every three hours). This air pressure information includes the vehicle ID of the shared vehicle 1, the sensor ID of each sensor 3, the correspondence relationship between the sensor ID and the wheel position, and the air pressure (or a physical quantity related to the air pressure) and temperature (or an outside air temperature related to the tire temperature) of each tire 2 detected by each sensor 3.

The reference information setting unit 33 sets reference information including a reference air pressure and a reference temperature of the tire 2. This reference information serves as a reference for determining the presence or absence of an air pressure abnormality in the tire 2 and the type of abnormality. The reference information may be, for example, a fixed value or a value that varies depending on a certain parameter. In the present embodiment, the reference information setting unit 33 sets an initial value as the reference air pressure by updating the initial value as needed based on the average value of the temperature-converted air pressure during a predetermined period, which will be described later.

Under the control of the control unit 40, the temperature-converted air pressure calculation unit 34 calculates a temperature-converted air pressure converted into air pressure at a reference temperature based on the acquired air pressure information (sensor information) and the set reference information. In general, the air pressure of the tires 2 tends to change depending on the air temperature, and therefore the air pressure may differ when the vehicle is in motion and when the vehicle is stopped, making it difficult to accurately manage the fluctuations in air pressure. Therefore, the temperature-converted air pressure calculation unit 34 converts the air pressure of the tire 2 into air pressure at the above-described reference temperature (for example, 20 °C) based on, for example, the Boyle-Charles law. This allows for consideration of fluctuations in air pressure due to changes in the temperature of the tire 2. In other words, it is possible to correct for external fluctuation factors (fluctuations in air pressure due to temperature changes), allowing for more accurate management of changes in air pressure.

The average value calculation unit 35 calculates the average value of the temperature-converted air pressure during a predetermined period. Specifically, the average value of the temperature-converted air pressure for the same tire 2 during a predetermined period in the past (for example, the most recent 10 days) is calculated. Changes in the weight of the shared vehicle 1 (the number of passengers and baggage) and changes in outside temperature due to seasonal fluctuations are also external fluctuation factors that change the air pressure of the tire 2. However, this configuration can set an appropriate reference air pressure that suppresses the influence of the above-described external fluctuation factors by updating the reference air pressure with the average value of the temperature-converted air pressure and can thus accurately determine the presence or absence of an air pressure abnormality in the tire 2.

The abnormality determination unit 36 determines whether there is an abnormality in the tire 2 and the type of the abnormality based on the result of comparing the calculated temperature-converted air pressure with the set reference air pressure. In this case, the abnormality in the tire 2 is mainly an air pressure abnormality. The type of abnormality in the tire 2 mainly refers to the situation of a decrease in air pressure, such as a puncture that causes a decrease in air pressure of 50 kPa or more per minute, a slow leak that causes a decrease in air pressure of about 5 to 20 kPa per day, or a natural leakage that causes a decrease in air pressure of several kPa to 30 kPa per month. In general, a slow leak causes the air pressure to decrease faster than a natural leakage and slower than a normal puncture. Therefore, it is difficult for the driver to notice the occurrence of a slow leak. In particular, in the case of a shared vehicle 1 for car sharing, the user (driver) does not drive the shared vehicle 1 on a daily basis, and therefore it is difficult to notice a slow leak even when the air pressure tends to decrease. On the other hand, if the slow leak progresses and the air pressure falls below a predetermined reference value, driving safety is impaired. Furthermore, in the case of a natural leakage, the tire 2 can usually be restored to the appropriate air pressure by refilling the tire 2 with air, but since a slow leak is a type of puncture, it is necessary to remove the tire from the rim and repair or replace the tire, for example. Therefore, there is a demand for accurate distinction between natural leakages and slow leaks and for rapid determination of slow leaks. In the present embodiment, when an air pressure abnormality occurs in the tire 2, the abnormality determination unit 36 can appropriately determine the air pressure abnormality by determining whether the abnormality type is a puncture, a slow leak, or a natural leakage.

The abnormality determination unit 36 includes a first abnormality determination unit 36A configured to determine that the type of abnormality is a puncture of the tire 2 when an air pressure abnormality in the tire 2 occurs and a second abnormality determination unit 36B configured to determine that the type of abnormality is a slow leak of the tire 2 or a natural leakage of the tire 2. Specifically, the first abnormality determination unit 36A determines that there is an abnormality in the tire 2 if a difference value between the reference air pressure and the temperature-converted air pressure is equal to or greater than a first threshold value K1. The first abnormality determination unit 36A determines that the type of abnormality is a normal puncture of the tire 2 if the difference value is equal to or greater than a second threshold value K2 that is greater than the first threshold value K1.

The first threshold value K1 is a threshold value at which at least a natural leakage of the tire 2 is estimated, and the second threshold value K2 is a threshold value at which a puncture of the tire 2 is estimated. These threshold values K1 and K2 are numerical values determined according to, for example, the “maximum air pressure” specified by JATMA (the Japan Automobile Tyre Manufacturers Association, Inc.). In the present embodiment, when the maximum air pressure of the tire 2 is 240 kPa, the first threshold value K1 is set to about 3% (8 kPa) of the maximum air pressure. This first threshold value K1 is preferably set to 2 to 5% of the maximum air pressure. The second threshold value K2 is set to about 20% (50 kPa) of the maximum air pressure. This second threshold value K2 is preferably set to 15 to 25% of the maximum air pressure. In this way, the first abnormality determination unit 36A can appropriately determine whether the tire 2 is punctured by determining the type of air pressure abnormality using two-stage threshold values.

On the other hand, when an air pressure abnormality occurs in the tire 2, the second abnormality determination unit 36B determines whether the type of abnormality is a slow leak or a natural leakage. Specifically, if the difference value is equal to or greater than the first threshold value K1 and less than the second threshold value K2, the second abnormality determination unit 36B compares this difference value with a set natural leakage threshold value K3. Then, if the difference value is equal to or less than the natural leakage threshold value K3, the second abnormality determination unit 36B determines that the type of abnormality is a natural leakage, and if the difference value is greater than the natural leakage threshold value K3, the second abnormality determination unit 36B determines that the type of abnormality is a slow leak.

This natural leakage threshold value K3 is a threshold value that distinguishes between a natural leakage and a slow leak in the tire 2, and is set based on the natural leakage air pressure that is estimated to naturally leak from the tire 2 during a predetermined unit period (for example, one month). Specifically, when the natural leakage air pressure that naturally leaks from the tire 2 with an initial air pressure immediately after filling (for example, maximum air pressure (240 kPa)) in one month is estimated to be, for example, 6% (14 kPa), then the natural leakage threshold value K3 is set to 6% (14 kPa). The natural leakage threshold value K3 is set to a value greater than the first threshold value K1 and less than the second threshold value K2. In the present embodiment, the unit period is set to one month, but it may be changed as appropriate as long as the condition that the natural leakage threshold value K3 is greater than the first threshold value K1 and less than the second threshold value K2 is satisfied.

The natural leakage air pressure estimation unit 37 estimates the air pressure (natural leakage air pressure) that decreases due to natural leakage in the tire 2 during a predetermined unit period (for example, one month). In general, the gas permeability of the rubber material constituting the tire 2 is known to be temperature dependent, and in particular, the gas permeability of the inner liner, which has a large contribution to the natural leakage rate of the tire 2, is known to correlate with the Arrhenius plot. Since the tire 2 is made of a viscoelastic material, it generates heat during running, causing the temperature inside the tire 2 to rise. Therefore, the amount of natural leakage from the tire 2 is greater when the tire 2 is in a dynamic (moving) state than when the tire 2 is in a static (stationary) state, and the static natural leakage rate and the dynamic natural leakage rate can change by several times to ten times. In the present embodiment, the natural leakage air pressure estimation unit 37 estimates the natural leakage air pressure based on the utilization rate of the shared vehicle 1. Specifically, for example, if an average stop time of the shared vehicle 1 in one day (24 hours) is T2, an average operating time T1 can be expressed as T1=24−T2. This utilization status (the average utilization time T1 and the average stop time T2) can be obtained from sensor information (for example, GNSS information, engine on/off information, vehicle speed pulse information, and the like) acquired by the information acquisition unit 32. If the static leakage rate of the tire 2 is ALs (%/month), the dynamic leakage rate is ALd (%/month), and the initial air pressure is P0 (kPa), the natural leakage air pressure ALtp leaking in one month (30 days) can be calculated using the following Formula (1). Here, α and β are correction coefficients that can be appropriately adjusted depending on tire structural factors that affect the natural leakage rate, such as the material and gauge of the inner liner, the number of belts, and the number of carcasses. For example, when the material of the inner liner is changed to a material that is twice as leak-resistant as before, and the contribution rate of the inner liner to the static and dynamic leakage rates is set to 40%, α and β can be set to 0.8. Different numerical values can be used for α and β, and the correction coefficients can be found from the results of actual measurements.

ALtp=P0×{α×ALs×((T1/24)÷30)+β×ALd×((T2/24)÷30)} (1)

In this way, the natural leakage air pressure estimation unit 37 calculates the natural leakage air pressure for a predetermined unit period by allocating the ratio according to the static and dynamic utilization statuses of the shared vehicle 1, and therefore can accurately estimate this natural leakage air pressure. The static leakage rate ALs and the dynamic leakage rate ALd each have temperature dependency, and therefore may be corrected by temperature.

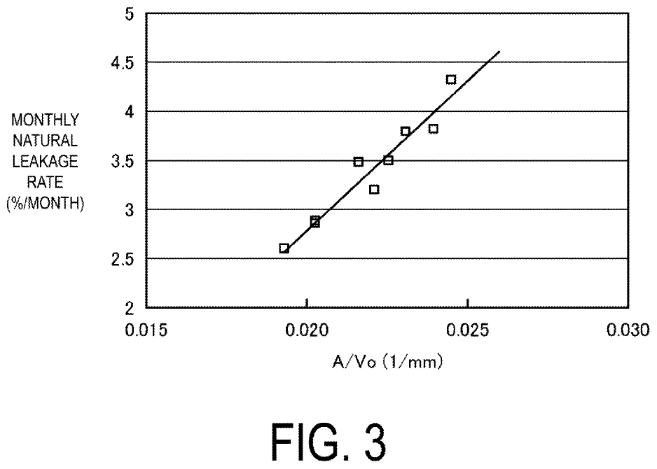

In the present embodiment, the natural leakage air pressure estimation unit 37 is configured to estimate the natural leakage air pressure based on the utilization rate of the shared vehicle 1, but the natural leakage air pressure can also be estimated using other methods. Specifically, the natural leakage air pressure estimation unit 37 estimates the natural leakage air pressure using a relational expression that indicates the relationship between a ratio A/V of an inner surface area A of the tire 2 to an internal volume V of the tire 2 and the natural leakage air pressure leaking in a predetermined unit period (one month). FIG. 3 is a graph illustrating the relationship between the ratio of the inner surface area of a tire to the internal volume of the tire and the natural leakage rate.

The graph illustrated in FIG. 3 shows the relationship between the ratio A/V (A/Vo) of a plurality of tires of representative sizes (nominal width: 175 to 225, inch: 14 to 16) and the natural leakage rate of the tires over one month, which are measured. It is possible to measure and map the static and dynamic natural leakage rates of all tire sizes in advance, but this would require a huge amount of testing man-hours. Therefore, in the present embodiment, a relational expression (regression expression) derived from the ratio A/V and the natural leakage rate of a tire of a reference representative size is used to derive an estimated natural leakage rate for the tire from the ratio A/V of the corresponding tire, thereby achieving both an improvement in testing efficiency and an improvement in prediction accuracy.

The inner surface area A refers to a surface area (mm²) of the internal space of the tire 2 that is filled with air, and the internal volume V refers to a volume (mm³) of the internal space. The inner surface area A and the internal volume V are treated with reference to numerical values when the target tire is mounted on the measurement rim. On the other hand, when the mounting rim is determined in advance, the numerical value when the tire is mounted on the mounting rim may be used. The inner surface area A and the internal volume V may be calculated using, for example, numerical values on a computer-aided design (CAD) drawing of the tire, or may be calculated from a computed tomography (CT) image of the tire captured under no-load conditions after the tire is inflated to the specified air pressure for the vehicle. Furthermore, detailed tire information may include tire structure information such as a tire size, a mounting position, a reference inner surface area, a reference internal volume, an inner liner gauge, the number of carcasses, a carcass TUH, and the number of belts. For example, the inner liner gauge can be substituted by the smallest inner liner gauge in the center of the tire, but if measurements are performed at five or more points equally spaced in the periphery direction and the average value is used, the accuracy of the inner surface area A and the internal volume V can be further improved.

In the present embodiment, the natural leakage air pressure estimation unit 37 can easily and accurately estimate the natural leakage air pressure using a relational expression that indicates the relationship between a ratio A/V of an inner surface area A of the tire 2 to an internal volume V of the tire 2 and the natural leakage rate leaking in a predetermined unit period (one month). As illustrated in FIG. 3, for example, when the ratio A/V of the inner surface area A to the internal volume V is 0.025, the natural leakage rate is 4.25 (%/month), and when the initial set air pressure as a reference is 240 kPa, the natural leakage rate decreases by about 10 kPa after a unit period (one month).

The natural leakage threshold value setting unit 38 sets the natural leakage threshold value K3 based on the natural leakage air pressure estimated by the natural leakage air pressure estimation unit 37. The natural leakage threshold value setting unit 38 sets the natural leakage threshold value K3 based on the natural leakage rate (%/month) estimated to be naturally leaked in one month, for example. Specifically, when the initial filling air pressure (maximum air pressure) is 240 kPa and the natural leakage rate is estimated to be 6% (14 kPa), the natural leakage threshold value setting unit 38 sets this 6% (14 kPa) as the natural leakage threshold value K3.

The storage unit 39 includes storage means such as a volatile or nonvolatile memory or an HDD. The storage unit 39 stores various programs to be executed by the control unit 40 and various types of calculated data. The storage unit 39 stores the air pressure information acquired by the information acquisition unit 32 every predetermined time as historical information for each vehicle ID (shared vehicle 1), including the air pressure and temperature of the tire 2 at the wheel position corresponding to the sensor ID. When air pressure maintenance is performed on the target shared vehicle 1, the storage unit 39 records this maintenance historical information.

The control unit 40 has a CPU and performs predetermined processing based on information received from the sensor receiving terminal 10, the administrator terminal 20, and the car sharing management server via the communication unit 31, or data stored in the storage unit 39. When it is determined that the air pressure abnormality of the target shared vehicle 1 is a puncture, the control unit 40 outputs the occurrence of a puncture in the tire 2 of the shared vehicle 1 to the administrator terminal 20 of the station of the shared vehicle 1 and to the car sharing management server. In this case, the car sharing management server checks whether a reservation for use of the shared vehicle 1 has been made on that day, and when a reservation for use has been made, transfers the reservation for use to another shared vehicle 1 of the same class and notifies the user of that fact. On the other hand, at the station side that is notified of the occurrence of the puncture through the administrator terminal 20, maintenance (repairing a puncture) of the tire 2 of the shared vehicle 1 is performed.

When it is determined that the air pressure abnormality of the target shared vehicle 1 is a slow leak, the control unit 40 outputs the occurrence of a slow leak in the tire 2 of the shared vehicle 1 to the administrator terminal 20 of the station of the shared vehicle 1 and to the car sharing management server. Generally, a slow leak is not severe enough to immediately stop the use of the shared vehicle 1 at that stage. Therefore, when a reservation for use of the shared vehicle 1 has been made on that day, the car sharing management server notifies the user of a request to refill the air in the shared vehicle 1 to be used. When the user performs air refilling, a discount coupon for the usage fee may be sent, for example. For example, if it is confirmed from the air pressure information from the sensor 3 that the tire has been refilled with air, a discount coupon can be automatically sent. On the other hand, at the station side that is notified of the occurrence of a slow leak through the administrator terminal 20, when there is no reservation for use of the shared vehicle 1, maintenance of the tire 2 (refilling air, checking for damage to the tire, air valve, wheel, or the like, repairing a puncture, or the like) is performed.

When it is determined that the air pressure abnormality of the target shared vehicle 1 is a natural leakage, the control unit 40 outputs the occurrence of a natural leakage in the tire 2 of the shared vehicle 1 to the administrator terminal 20 of the station of the shared vehicle 1 and to the car sharing management server. Generally, natural leakages occur during normal use and do not stop the shared vehicle 1 from being used. Therefore, when a reservation for use of the shared vehicle 1 has been made on that day, the car sharing management server notifies the user of a request to refill the air in the shared vehicle 1 to be used. When the user performs air refilling, a discount coupon for the usage fee may be sent, for example. On the other hand, at the station side that is notified of the occurrence of a natural leakage through the administrator terminal 20, when there is no reservation for use of the shared vehicle 1, maintenance of the tire 2 (refilling air, checking for damage to the tire, air valve, wheel, or the like) is performed.

The administrator terminal 20 is a terminal device provided at a station where the shared vehicle 1 is parked. As illustrated in FIG. 1, the administrator terminal 20 includes a communication unit 21, a storage unit 22, a display unit 23, an input unit 24, a notification unit 25, and a control unit 26. The communication unit 21 is configured to be able to wirelessly communicate with the cloud server 30 via the communication network 50. The communication unit 21 receives, from the cloud server 30, information about the presence or absence of an air pressure abnormality of the target shared vehicle 1 and the type of air pressure abnormality. When a station worker inputs a command to refill air or repair a puncture in a tire 2 of a shared vehicle 1, the communication unit 21 transmits maintenance completion information to the cloud server 30 along with the vehicle ID of the shared vehicle 1. Here, when the cloud server 30 receives the maintenance completion information, the cloud server 30 transmits a maintenance completion report to the car sharing management server. This makes it possible to accept new reservations for use of shared vehicles 1 one by one for which maintenance has been completed.

The storage unit 22 includes storage means such as a volatile or nonvolatile memory or an HDD. The storage unit 22 stores various programs to be executed by the control unit 26 and various types of data.

The display unit 23 is disposed in the approximate center of the terminal and is a display screen that displays various types of information and provides the information to the station worker. The display unit 23 can display various types of information about the target shared vehicle 1 based on the worker's operation.

The input unit 24 is, for example, a touch panel formed on the display unit 23 in an overlapping manner, and is used to input various types of information to the administrator terminal 20. When the notification unit 25 receives information about an air pressure abnormality of the target shared vehicle 1 from the cloud server 30, the notification unit 25 notifies the user of that fact. The notification unit 25 may, for example, display the location information of the shared vehicle 1 and the tire 2 in which the air pressure abnormality has occurred on the display unit 23, and may also be configured to turn on an indicator light or emit an alarm sound in addition to this. The control unit 26 has a CPU and performs predetermined processing based on information received from the cloud server 30 via the communication unit 21, or data stored in the storage unit 22.

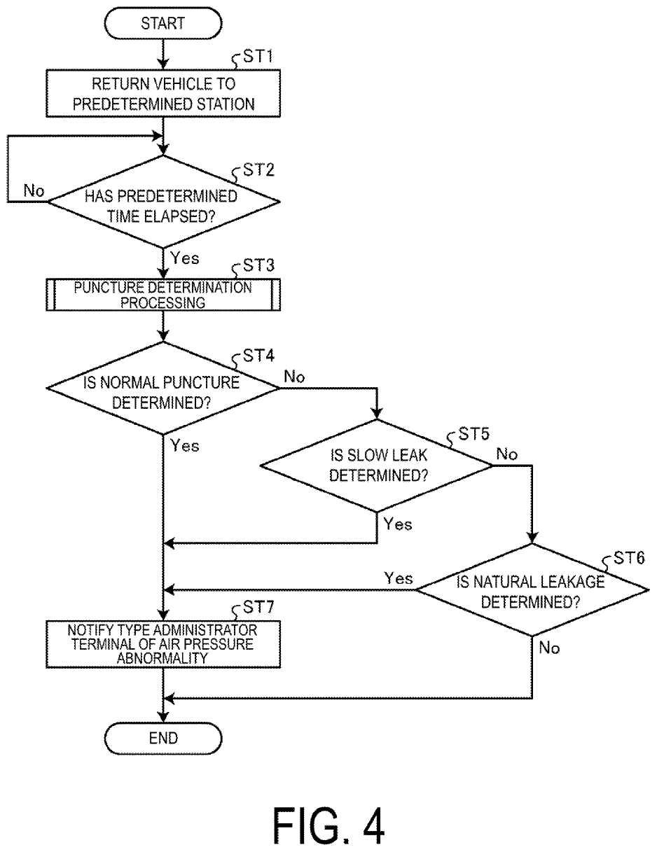

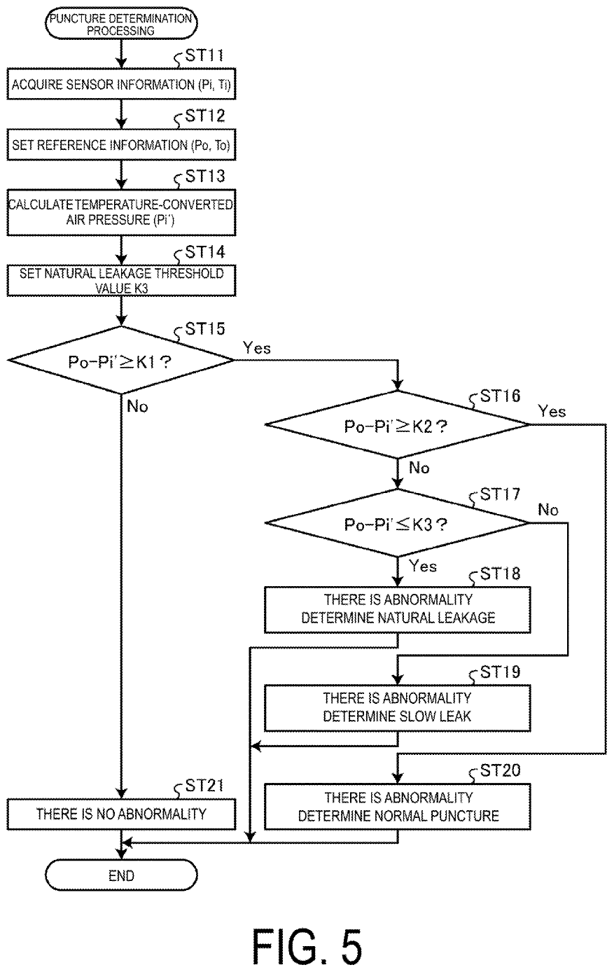

Next, the operation of the cloud server 30 according to the present embodiment will be described. FIG. 4 is a flowchart illustrating an operation procedure of the air pressure management system. FIG. 5 is a flowchart illustrating an operation procedure of the puncture determination process of the air pressure management device illustrated in FIG. 4.

As illustrated in FIG. 4, when the shared vehicle 1 is returned to a station (step ST1), the control unit 26 of the administrator terminal 20 determines whether an arbitrary predetermined time has elapsed since the return (step ST2). This predetermined time corresponds to a period until the tires 2 of the shared vehicle 1 are cooled, and the control unit 26 determines whether, for example, 15 minutes have elapsed since the return. In this determination, when the predetermined time has not yet elapsed (step ST2; No), there may be a large fluctuation (decrease) in the temperature of the tire 2, and in this case, the air pressure will also fluctuate (decrease). Therefore, by waiting until the predetermined time has elapsed, an accurate determination can be made.

On the other hand, when the predetermined time has elapsed (step ST2; Yes), the control unit 40 of the cloud server 30 performs a puncture determination process (step ST3). Then, the control unit 40 of the cloud server 30 determines whether a normal puncture determination is made in the tire 2 of the shared vehicle 1 (step ST4), and when a normal puncture determination is made (step ST4; Yes), the process proceeds to step ST7. When a normal puncture determination is not made (step ST4; No), the control unit 40 of the cloud server 30 determines whether a slow leak determination is made in the tire 2 of the shared vehicle 1 (step ST5). In this determination, when a slow leak determination is made (step ST5; Yes), the process proceeds to step ST7, and when a slow leak determination is not made (step ST5; No), the control unit 40 of the cloud server 30 determines whether a natural leakage determination is made in the tire 2 of the shared vehicle 1 (step ST6). In this determination, when a natural leakage determination is made (step ST6; Yes), the process proceeds to step ST7, and when a natural leakage determination is not made (step ST6; No), the process ends.

When a normal puncture determination, a slow leak determination, or a natural leakage determination is made, the control unit 40 of the cloud server 30 notifies the administrator terminal 20 that manages the station where the target shared vehicle 1 is parked of the type of air pressure abnormality via the communication unit 31 (step ST7). Specifically, when it is determined that the type of air pressure abnormality of the target shared vehicle 1 is a puncture (normal puncture), the control unit 40 notifies the administrator terminal 20 of the station of the shared vehicle 1 and the car sharing management server of the occurrence of a puncture in the tire 2 of the shared vehicle 1. In this case, the car sharing management server checks whether a reservation for use of the shared vehicle 1 has been made on that day, and when a reservation for use has been made, transfers the reservation for use to another shared vehicle 1 of the same class and notifies the user of that fact. When the administrator terminal 20 is notified of the occurrence of a puncture, the station side repairs the puncture in the tire 2 of the shared vehicle 1.

When it is determined that the type of air pressure abnormality of the target shared vehicle 1 is a slow leak, the control unit 40 notifies the administrator terminal 20 of the station of the shared vehicle 1 and the car sharing management server of the occurrence of a slow leak in the tire 2 of the shared vehicle 1. In this case, when a reservation for use of the shared vehicle 1 has been made on that day, it is preferable that the car sharing management server notify the user of a request to refill the air in the shared vehicle 1 to be used. When the user performs air refilling, a discount coupon for the usage fee is sent, for example. On the other hand, at the station side that is notified of the occurrence of a slow leak through the administrator terminal 20, when there is no reservation for use of the shared vehicle 1, checking for damage to the air valve or wheel of the tire 2 or repairing a puncture is performed.

When it is determined that the type of air pressure abnormality of the target shared vehicle 1 is a natural leakage, the control unit 40 notifies the administrator terminal 20 of the station of the shared vehicle 1 and the car sharing management server of the occurrence of a natural leakage in the tire 2 of the shared vehicle 1. In this case, when a reservation for use of the shared vehicle 1 has been made on that day, it is preferable that the car sharing management server notify the user of a request to refill the air in the shared vehicle 1 to be used. When the user performs air refilling, a discount coupon for the usage fee is sent, for example. On the other hand, at the station side that is notified of the occurrence of a natural leakage through the administrator terminal 20, when there is no reservation for use of the shared vehicle 1, maintenance of the tire 2 (refilling air or checking for damage to the air valve or wheel of the tire 2) is performed.

Next, the puncture determination process of the cloud server 30 will be described. As illustrated in FIG. 5, the cloud server 30 acquires air pressure information (sensor information (Pi, Ti)) of each tire 2 of the shared vehicle 1 received from the sensor receiving terminal 10 at a predetermined timing using the information acquisition unit 32 (step ST11). This air pressure information includes the vehicle ID of the shared vehicle 1, the sensor ID of each sensor 3, the correspondence relationship between the sensor ID and the wheel position, and the air pressure and temperature of each tire 2 detected by each sensor 3.

Next, the cloud server 30 sets reference information (Po, To) including the reference air pressure and the reference temperature of the tire 2 by the reference information setting unit 33 (step ST12). In the present embodiment, the reference information setting unit 33 sets the average value of the temperature-converted air pressure of the same tire 2 during a predetermined period in the past (for example, the most recent 10 days) as the reference temperature.

Next, the cloud server 30 calculates the temperature-converted air pressure (Pi′) converted to the air pressure at the reference temperature based on the air pressure information (sensor information (Pi, Ti)) and the set reference information (Po, To) using the temperature-converted air pressure calculation unit 34 (step ST13). The temperature-converted air pressure calculation unit 34 converts the air pressure (Pi) of the tire 2 into air pressure at a reference temperature (To) based on, for example, the Boyle-Charles law.

Next, the cloud server 30 sets the natural leakage threshold value K3 based on the natural leakage air pressure using the natural leakage threshold value setting unit 38 (step ST14). In this case, the natural leakage air pressure may be estimated based on the utilization rate of the shared vehicle 1 or may be estimated based on a predetermined relational expression specified in advance.

Next, the cloud server 30 determines whether the difference value between the reference air pressure (Po) and the temperature-converted air pressure (Pi′) is equal to or greater than the first threshold value K1 using the first abnormality determination unit 36A (step ST15). The first threshold value K1 is a threshold value for determining the presence or absence of an air pressure abnormality, and is a threshold value at which at least natural leakage from the tire 2 is estimated. In the present embodiment, when the maximum air pressure of the tire 2 specified by JATMA is 240 kPa, the first threshold value K1 is set to about 3% (8 kPa) of the maximum air pressure. In this determination, if the difference value between the reference air pressure (Po) and the temperature-converted air pressure (Pi′) is equal to or greater than the first threshold value K1 (step ST15; Yes), the cloud server 30 proceeds to step ST16.

When the difference value between the reference air pressure (Po) and the temperature-converted air pressure (Pi′) is not equal to or greater than the first threshold value K1 (step ST15; No), the first abnormality determination unit 36A determines that there is no air pressure abnormality in the tire 2 of the shared vehicle 1 (step ST21) and ends the process.

Next, the cloud server 30 determines whether the difference value between the reference air pressure (Po) and the temperature-converted air pressure (Pi′) is equal to or greater than the second threshold value K2 using the first abnormality determination unit 36A (step ST16). The second threshold value K2 is a reference for determining whether the type of air pressure abnormality is a puncture or a slow leak of the tire 2, and is a threshold value at which a puncture of the tire 2 is estimated. The second threshold value K2 is a value greater than the first threshold value K1. In the present embodiment, when the maximum air pressure of the tire 2 specified by JATMA is 240 kPa, the second threshold value K2 is set to about 20% (50 kPa) of the maximum air pressure. In this determination, when the difference value between the reference air pressure (Po) and the temperature-converted air pressure (Pi′) is not equal to or greater than the second threshold value K2 (step ST16; No), the cloud server 30 proceeds to step ST17.

On the other hand, in this determination, if the difference value between the reference air pressure (Po) and the temperature-converted air pressure (Pi′) is equal to or greater than the second threshold value K2 (step ST16; Yes), the cloud server 30 proceeds to step ST20. In this case, the first abnormality determination unit 36A determines that the abnormality type of the tire 2 of the shared vehicle 1 is a puncture abnormality (step ST20), and ends the process. In this way, in the present embodiment, the first abnormality determination unit 36A can appropriately determine the presence or absence of an air pressure abnormality and whether the type of abnormality is a puncture of the tire 2 using the two-stage threshold values K1 and K2.

Next, the cloud server 30 determines whether the difference value between the reference air pressure (Po) and the temperature-converted air pressure (Pi′) is equal to or less than the natural leakage threshold value K3 using the second abnormality determination unit 36B (step ST17). This natural leakage threshold value K3 is set in step ST14 described above, and serves as a reference for determining whether the type of air pressure abnormality is a slow leak or a natural leakage of the tire 2. In the present embodiment, when the initial filling air pressure of the tire 2 is set to the maximum air pressure of the tire 2 (240 kPa) specified by JATMA, and the natural leakage air pressure that naturally leaks during a predetermined unit period (one month) is estimated to be 6% (14 kPa), this 6% (14 kPa) is set as the natural leakage threshold value K3. The natural leakage threshold value K3 is set to a value greater than the first threshold value K1 and less than the second threshold value K2.

In this determination, if the difference value between the reference air pressure (Po) and the temperature-converted air pressure (Pi′) is equal to or less than the natural leakage threshold value K3 (step ST17; Yes), the cloud server 30 proceeds to step ST18. In this case, the second abnormality determination unit 36B determines that the abnormality type of the tire 2 of the shared vehicle 1 is a natural leakage (step ST18), and ends the process. On the other hand, when the difference value between the reference air pressure (Po) and the temperature-converted air pressure (Pi′) is not equal to or less than the natural leakage threshold value K3 (step ST17; No), the cloud server 30 proceeds to step ST19. In this case, the second abnormality determination unit 36B determines that the abnormality type of the tire 2 of the shared vehicle 1 is a slow leak (step ST19), and ends the process. In this way, in the present embodiment, the second abnormality determination unit 36B can appropriately determine whether the type of air pressure abnormality is a slow leak of the tire 2 or a natural leakage of the tire 2 by using the natural leakage threshold value K3. Therefore, based on the determination result, maintenance work (air refilling or repairing a puncture) for the tire 2 can be appropriately determined, thereby reducing the amount of work required.

### Second Embodiment

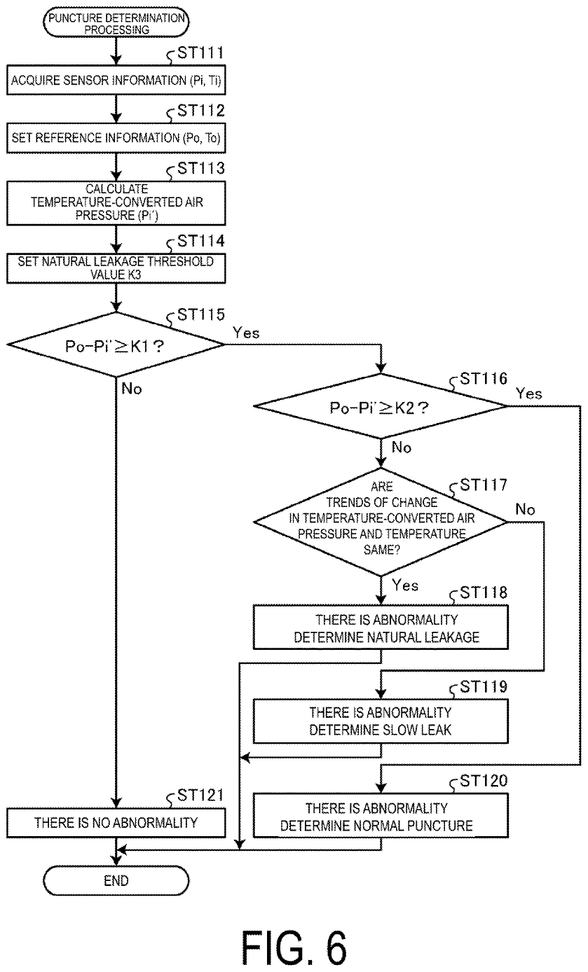

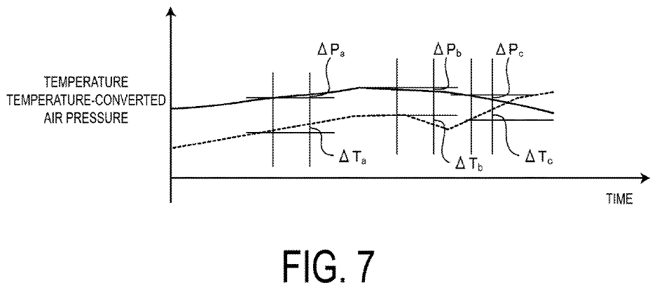

Next, a second embodiment will be described. FIG. 6 is a flowchart illustrating an operation procedure of a puncture determination process according to the second embodiment. FIG. 7 is a graph illustrating changes in temperature-converted air pressure and temperature of a tire over time. In the first embodiment described above, the second abnormality determination unit 36B is configured to determine whether the type of air pressure abnormality is a slow leak of the tire 2 or a natural leakage of the tire 2 using the set natural leakage threshold value K3. In contrast, in the second embodiment, the second abnormality determination unit 36B is configured to determine the trends of changes in the temperature-converted air pressure and the temperature at two temporally consecutive points based on a set of data for the temperature-converted air pressure and the temperature, and to determine whether the type of air pressure abnormality is a slow leak of the tire 2 or a natural leakage of the tire 2 based on the difference in these trends. The configuration of the cloud server 30 (air pressure management device) is almost the same as that of the first embodiment, and the puncture determination process illustrated in FIG. 6 is the same as that of the first embodiment except that step ST117 is different from step ST17 of the first embodiment. Therefore, the same configurations and operations will not be described.

As illustrated in FIG. 6, when the difference value between the reference air pressure (Po) and the temperature-converted air pressure (Pi′) is not equal to or greater than the second threshold value K2 (step ST116; No), the cloud server 30 proceeds to step ST117. Next, the cloud server 30 determines whether the trends of changes in the temperature-converted air pressure and the temperature at two temporally consecutive points are the same using the second abnormality determination unit 36B (step ST117). Generally, the tire 2 is filled with air at a predetermined pressure (temperature-converted air pressure) in an enclosed space, and this air pressure changes in the same trend as temperature, for example, according to the Boyle-Charles law. Specifically, if the temperature inside the tire 2 rises, the temperature-converted air pressure also rises, and if the temperature inside the tire 2 falls, the temperature-converted air pressure also falls. On the other hand, if the trends of changes in the temperature-converted air pressure and the temperature are different, that is, if the temperature-converted air pressure is decreasing or remaining constant while the temperature inside the tire 2 is rising, it is considered that an abnormality has occurred in the tire 2.

As illustrated in FIG. 7, a temperature difference ΔTa between any two temporally consecutive points is positive (plus) for the temperature inside the tire 2, and a temperature-converted air pressure difference ΔPa is also positive (plus). In this case, the trends of changes in the temperature-converted air pressure and the temperature are the same. Similarly, a temperature difference ΔTb and a temperature-converted air pressure difference ΔPb between any two temporally consecutive points are both negative (minus), and the trends of changes in the temperature-converted air pressure and the temperature are the same.

On the other hand, a temperature difference ΔTc between any two temporally consecutive points is positive (plus), whereas a temperature-converted air pressure difference ΔPc is negative (minus), and the signs of the changes are different. In this case, since the trends of changes in the temperature-converted air pressure and the temperature are different (not the same), an air pressure abnormality is determined.

In the present embodiment, when the second abnormality determination unit 36B determines that the trend of change in the temperature-converted air pressure and the trend of change in the temperature are the same (step ST117; Yes), the cloud server 30 proceeds to step ST118. In this case, the second abnormality determination unit 36B determines that the abnormality type of the tire 2 of the shared vehicle 1 is a natural leakage (step ST118), and ends the process. On the other hand, when the trend of change in the temperature-converted air pressure and the trend of change in the temperature are different (step ST117; No), the cloud server 30 proceeds to step ST119. In this case, the second abnormality determination unit 36B determines that the abnormality type of the tire 2 of the shared vehicle 1 is a slow leak (step ST119), and ends the process.

In this way, in the present embodiment, the second abnormality determination unit 36B can determine the trends of changes in the temperature-converted air pressure and the temperature at two temporally consecutive points based on a set of data for the temperature-converted air pressure and the temperature and appropriately determine whether the type of air pressure abnormality is a slow leak of the tire 2 or a natural leakage of the tire 2 based on the difference in these trends. Therefore, based on the determination result, maintenance work (air refilling or repairing a puncture) for the tire 2 can be appropriately determined, thereby reducing the amount of work required. It is sufficient for the second abnormality determination unit 36B to be able to determine the trends of changes in the temperature-converted air pressure and the temperature at least at two temporally consecutive points, and in addition to the configuration described above, the second abnormality determination unit 36B may be configured, for example, to use a plurality of sets of data for the temperature-converted air pressure and the temperature to determine approximate expressions for the temperature-converted air pressure and the temperature, and appropriately determine whether the type of air pressure abnormality is a slow leak of the tire 2 or a natural leakage of the tire 2 based on the difference in the sign (positive or negative) of the slope of these approximate expressions.

### Third Embodiment

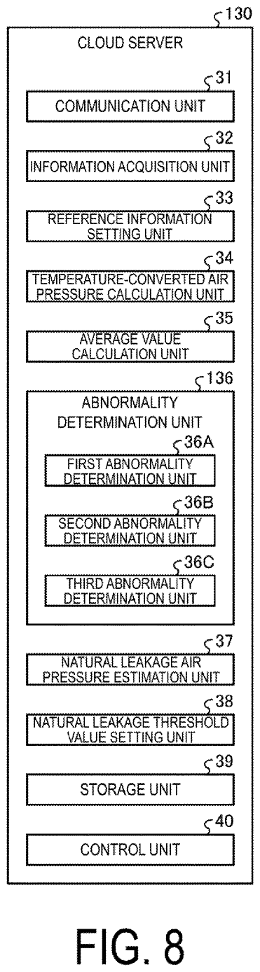

Next, a third embodiment will be described. FIG. 8 is a block diagram illustrating a functional configuration of a cloud server according to the third embodiment. The third embodiment differs from the first and second embodiments in that an abnormality determination unit 136 of a cloud server 130 (air pressure management device) includes a third abnormality determination unit 36C. The other configurations are almost the same as those of the above-described embodiments, and therefore the description thereof will be omitted.

The storage unit 39 of the cloud server 130 stores a group of data indicating the correspondence relationship between the temperature-converted air pressure of the tire 2, the temperature, information about the utilization of the shared vehicle 1, and information about the tire, and a learning model generated using the group of data. This group of data is a collection of a large number of sets of data for the temperature of the tire 2 and the temperature-converted air pressure converted using that temperature, and also includes information about the vehicle utilization corresponding to this set of data (for example, GNSS information, engine on/off information, vehicle speed pulse information, or the like) and information about the tire (for example, tire size, mounting position, reference natural leakage rate, inner surface area, internal volume, or the like), and a learning model is generated by machine-learning this group of data as features. Instead of the temperature-converted air pressure of the tire 2, a physical quantity correlated with the air pressure (for example, the wheel rotation speed) may be used. The outside air temperature may also be used instead of the tire temperature. In this configuration, for example, even in a configuration in which a TPMS sensor (sensor 3) is not provided in the tire 2, the air pressure of the tire 2 can be indirectly estimated. Therefore, for example, users, mobility service providers, taxi operators, and the like who use vehicles equipped with an indirect TPMS can easily manage the system while keeping implementation costs down without having to add a new TPMS sensor. In this way, by customizing the air pressure management device and the air pressure management method, it is possible to appropriately determine air pressure abnormalities while meeting the diverse needs of users.

The third abnormality determination unit 36C of the abnormality determination unit 136 determines the type of air pressure abnormality using the above-described group of data. Specifically, a learning model is generated in advance using techniques such as decision trees or random forests, and then the temperature-converted air pressure of the tire 2, acquired at a predetermined timing, the temperature, information about the utilization of shared vehicle 1, and information about the tire are sequentially input to determine the presence or absence of an air pressure abnormality and to easily determine whether the type of air pressure abnormality is a natural leakage, a slow leak, or a puncture. The learning model can be updated using a group of data additionally acquired after a certain period of time has elapsed. Regular updates can improve the accuracy of the determination.

In the present embodiment, the determination of an air pressure abnormality by the third abnormality determination unit 36C is performed independently of the determination of an air pressure abnormality by the first abnormality determination unit 36A and the second abnormality determination unit 36B described above, and the final determination is made by combining each determination. For example, the determinations made by the first abnormality determination unit 36A and the second abnormality determination unit 36B described above may be the main determination, and the determination of an air pressure abnormality by the third abnormality determination unit 36C may be the secondary determination, and when the two differ, the result of the main determination may take priority. The determination of an air pressure abnormality by the third abnormality determination unit 36C may be the main determination, and the determinations made by the first abnormality determination unit 36A and the second abnormality determination unit 36B may be the secondary determinations.

As described above, the cloud server 30 according to the present embodiment includes: the information acquisition unit 32 configured to acquire sensor information including the air pressure and temperature of the tire 2 mounted on the shared vehicle 1 at a predetermined timing; the reference information setting unit 33 configured to set reference information including reference air pressure and reference temperature of the tire 2; the temperature-converted air pressure calculation unit 34 configured to calculate the temperature-converted air pressure of the tire 2 at the reference temperature based on the sensor information and the reference information; and the abnormality determination unit 36 configured to determine the presence or absence of an abnormality in the tire 2 and the type of the abnormality based on a result of comparison between the reference air pressure and the temperature-converted air pressure. The abnormality determination unit 36 includes the first abnormality determination unit 36A configured to determine that there is an abnormality in the tire 2 if a difference value between the reference air pressure and the temperature-converted air pressure is equal to or greater than a first threshold value K1 and determine that the type of the abnormality is a puncture of the tire 2 if the difference value is equal to or greater than a second threshold value K2 that is greater than the first threshold value and the second abnormality determination unit 36B configured to determine whether the type of the abnormality is a slow leak of the tire 2 or a natural leakage of the tire 2 if the difference value is equal to or greater than the first threshold value K1 and less than the second threshold value K2. This configuration can determine the presence or absence of an air pressure abnormality in the tire 2 and the type of abnormality with high accuracy by using the two-stage threshold values K1 and K2.

The cloud server 30 according to the present embodiment includes: the natural leakage air pressure estimation unit 37 that estimates a natural leakage air pressure of the tire 2 during a predetermined unit period; and the natural leakage threshold value setting unit 38 that sets a natural leakage threshold value K3 corresponding to the natural leakage air pressure, and the second abnormality determination unit 36B compares the difference value with the natural leakage threshold value K3 if the difference value is equal to or greater than the first threshold value K1 and less than the second threshold value K2, determines that the type of the abnormality is the natural leakage if the difference value is equal to or less than the natural leakage threshold value K3, and determines that the type of the abnormality is the slow leak if the difference value is greater than the natural leakage threshold value K3. This configuration can appropriately distinguish between a natural leakage and a slow leak by using the natural leakage threshold value K3.

In the cloud server 30 according to the present embodiment, the natural leakage air pressure estimation unit 37 estimates the natural leakage air pressure based on a utilization rate of the shared vehicle 1. Therefore, the natural leakage air pressure can be estimated with high accuracy.

In the cloud server 30 according to the present embodiment, the natural leakage air pressure estimation unit 37 estimates the natural leakage air pressure using the relational expression that indicates the relationship between the ratio A/V of the inner surface area A of the tire 2 to the internal volume V of the tire 2 and the natural leakage rate. Therefore, the natural leakage air pressure can be estimated easily and accurately.

In the cloud servers 30 according to the present embodiment, the second abnormality determination unit 36B determines trends of changes in the temperature-converted air pressure and the temperature at two temporally consecutive points based on a set of data of the temperature-converted air pressure and the temperature, determines that the type of the abnormality is the natural leakage if the trend of change in the temperature-converted air pressure and the trend of change in the temperature are the same and determines that the type of the abnormality is the slow leak if the trend of change in the temperature-converted air pressure and the trend of change in the temperature are different. This configuration can appropriately determine whether the type of air pressure abnormality is a slow leak of the tire 2 or a natural leakage of the tire 2.

The cloud server 130 according to the present embodiment includes: the storage unit 39 configured to store a group of data indicating a correspondence relationship among the air pressure of the tire 2 or the physical quantity correlated with the air pressure, the temperature of the tire 2 or the outside air temperature, information about utilization of the vehicle, and information about the tire 2; and the third abnormality determination unit 36C configured to classify the type of the abnormality in the tire 2 into the puncture, the slow leak, and the natural leakage by using the group of data as learning data. Therefore, it is possible to easily determine whether the type of air pressure abnormality is a natural leakage, a slow leak, or a puncture.

The cloud server 30 according to the present embodiment includes the average value calculation unit 35 configured to calculate an average value of the temperature-converted air pressure during a predetermined period. The reference information setting unit 33 sets the average value of the temperature-converted air pressure as the reference air pressure. This configuration periodically updates the reference air pressure with the average value of the temperature-converted air pressure, can use an appropriate reference air pressure, and can determine the presence or absence of an air pressure abnormality in the tire 2 with high accuracy.

In the cloud server 30 according to the present embodiment, the information acquisition unit 32, the temperature-converted air pressure calculation unit 34, and the abnormality determination unit 36 perform an operation after the shared vehicle 1 is parked in a specified parking space and a predetermined time has elapsed after end of driving of the shared vehicle 1. In this configuration, since the tire 2 is cooled to a certain extent, the abnormality determination unit 36 can accurately perform the puncture determination process.

In the cloud server 30 according to the present embodiment, the vehicle is a shared vehicle to be shared by unspecified users. Therefore, for example, it is possible to appropriately determine the presence or absence of an air pressure abnormality in the tire 2 of the shared vehicle 1 to be used for car sharing and the type of the abnormality.

Although the embodiments of the present technology have been described above, the present technology is not limited to the above-described embodiments. In the above-described embodiments, the cloud server 30 managed the air pressure of the tires 2 mounted on the shared vehicles 1 used in the car sharing business, but the cloud server 30 may also manage the air pressure of the tires 2 mounted on the vehicles of pre-registered users, for example.

1. An air pressure management device, comprising:
an information acquisition unit configured to acquire sensor information including air pressure and temperature of tires mounted on a vehicle at a predetermined timing;
a reference information setting unit configured to set reference information including reference air pressure and reference temperature of a tire of the tires;
a temperature-converted air pressure calculation unit configured to calculate temperature-converted air pressure of the tire at the reference temperature based on the sensor information and the reference information; and
an abnormality determination unit configured to determine presence or absence of an abnormality in the tire and a type of the abnormality based on a result of comparison between the reference air pressure and the temperature-converted air pressure;
the abnormality determination unit comprising
a first abnormality determination unit configured to determine that there is an abnormality in the tire if a difference value between the reference air pressure and the temperature-converted air pressure is equal to or greater than a first threshold value and determine that the type of the abnormality is a puncture of the tire if the difference value is equal to or greater than a second threshold value that is greater than the first threshold value and
a second abnormality determination unit configured to determine whether the type of the abnormality is a slow leak of the tire or a natural leakage of the tire if the difference value is equal to or greater than the first threshold value and less than the second threshold value.

2. The air pressure management device according to claim 1, comprising:
a natural leakage air pressure estimation unit configured to estimate natural leakage air pressure of the tire during a predetermined unit period; and
a natural leakage threshold value setting unit configured to set a natural leakage threshold value corresponding to the natural leakage air pressure, wherein
the second abnormality determination unit compares the difference value with the natural leakage threshold value if the difference value is equal to or greater than the first threshold value and less than the second threshold value, determines that the type of the abnormality is the natural leakage if the difference value is equal to or less than the natural leakage threshold value, and determines that the type of the abnormality is the slow leak if the difference value is greater than the natural leakage threshold value.

3. The air pressure management device according to claim 2, wherein the natural leakage air pressure estimation unit estimates the natural leakage air pressure based on a utilization rate of the vehicle.

4. The air pressure management device according to claim 2, wherein the natural leakage air pressure estimation unit estimates the natural leakage air pressure using a relational expression that indicates a relationship between a ratio of an inner surface area of the tire to an internal volume of the tire and the natural leakage air pressure.

5. The air pressure management device according to claim 1, wherein
the second abnormality determination unit
determines trends of changes in the temperature-converted air pressure and the temperature at least at two temporally consecutive points based on a set of data of the temperature-converted air pressure and the temperature,
determines that the type of the abnormality is the natural leakage if the trend of change in the temperature-converted air pressure and the trend of change in the temperature are the same, and determines that the type of the abnormality is the slow leak if the trend of change in the temperature-converted air pressure and the trend of change in the temperature are different.

6. The air pressure management device according to claim 1, comprising:
a storage unit configured to store a group of data indicating a correspondence relationship among an air pressure of the tire or a physical quantity correlated with the air pressure, a temperature of the tire or an outside air temperature, information about utilization of the vehicle, and information about the tire; and
a third abnormality determination unit configured to classify the type of the abnormality in the tire into the puncture, the slow leak, and the natural leakage by using the group of data as learning data.

7. The air pressure management device according to claim 1, comprising
an average value calculation unit configured to calculate an average value of the temperature-converted air pressure during a predetermined period, wherein
the reference information setting unit sets the average value of the temperature-converted air pressure as the reference information.

8. The air pressure management device according to claim 1, wherein the information acquisition unit, the temperature-converted air pressure calculation unit, and the abnormality determination unit perform an operation after the vehicle is parked in a specified parking space and a predetermined time has elapsed after end of driving of the vehicle.

9. The air pressure management device according to claim 8, wherein the vehicle is a shared vehicle to be shared by unspecified users.

10. An air pressure management device, comprising:
an information acquisition unit configured to acquire sensor information including air pressure and temperature of tires mounted on a vehicle at a predetermined timing;
a reference information setting unit configured to set reference information including reference air pressure and reference temperature of a tire of the tires;
a temperature-converted air pressure calculation unit configured to calculate temperature-converted air pressure of the tire at the reference temperature based on the sensor information and the reference information; and
an abnormality determination unit configured to determine presence or absence of an abnormality in the tire and a type of the abnormality based on a result of comparison between the reference air pressure and the temperature-converted air pressure,
the abnormality determination unit
determines trends of changes in the temperature-converted air pressure and the temperature at least at two temporally consecutive points based on a set of data of the temperature-converted air pressure and the temperature,
determines that the type of the abnormality is a natural leakage if the trend of change in the temperature-converted air pressure and the trend of change in the temperature are the same, and
determines that the type of the abnormality is a slow leak if the trend of change in the temperature-converted air pressure and the trend of change in the temperature are different.

11. An air pressure management method, comprising:
acquiring sensor information including air pressure and temperature of tires mounted on a vehicle at a predetermined timing;
setting reference information including reference air pressure and reference temperature of a tire of the tires;
calculating temperature-converted air pressure of the tire at the reference temperature based on the sensor information and the reference information; and
determining presence or absence of an abnormality in the tire and a type of the abnormality based on a result of comparison between the reference air pressure and the temperature-converted air pressure;
the step of determining presence or absence of an abnormality in the tire and a type of the abnormality comprising
determining that there is an abnormality in the tires if a difference value between the reference air pressure and the temperature-converted air pressure is equal to or greater than a first threshold value,
determining that the type of the abnormality is a puncture of the tire if the difference value is equal to or greater than a second threshold value that is greater than the first threshold value, and
determining whether the type of the abnormality is a slow leak of the tire or a natural leakage of the tire if the difference value is equal to or greater than the first threshold value and less than the second threshold value.

12. An air pressure management method, comprising:
acquiring sensor information including air pressure and temperature of tires mounted on a vehicle at a predetermined timing;
setting reference information including reference air pressure and reference temperature of a tire of the tires;
calculating temperature-converted air pressure of the tire at the reference temperature based on the sensor information and the reference information; and
determining presence or absence of an abnormality in the tire and a type of the abnormality based on a result of comparison between the reference air pressure and the temperature-converted air pressure,
the step of determining presence or absence of an abnormality in the tire and a type of the abnormality comprising
determining trends of changes in the temperature-converted air pressure and the temperature at least at two temporally consecutive points based on a set of data of the temperature-converted air pressure and the temperature,
determining that the type of the abnormality is a natural leakage if the trend of change in the temperature-converted air pressure and the trend of change in the temperature are the same, and
determining that the type of the abnormality is a slow leak if the trend of change in the temperature-converted air pressure and the trend of change in the temperature are different.
